(19) United States
(12) Patent Application Publication
(10) Pub. No.: US 2012/0233236 A1
(43) Pub. Date: Sep. 13, 2012

(54) CLOUD-BASED SYSTEM FOR SERVING SERVICE REQUEST OF EMBEDDED DEVICE BY CLOUD COMPUTING AND RELATED CLOUD-BASED PROCESSING METHOD THEREOF

(76) Inventors: Min-Shu Chen, New Taipei City (TW); Ching-Chieh Wang, Yilan County (TW); Cheng-Chung Tseng, Hsinchu County (TW); Hsiang Wang, Hsinchu City (TW); Shih-Hung Liu, Hsinchu City (TW); Kun-Ming Tien, Hsinchu City (TW)

(21) Appl. No.: 13/042,384

(22) Filed: Mar. 7, 2011

(51) Int. Cl. G06F 15/16

(52) U.S. Cl. 709/201

(57) ABSTRACT

A cloud-based system includes a cloud server system with cloud computing capability, and an embedded device coupled to the cloud server system through a network. The embedded device is configured to request the cloud server system for a specific service by generating a service request to the cloud server system. A cloud-based processing method includes: utilizing an embedded device to generate a service request for a specific service, and serving the service request by cloud computing.

### BACKGROUND

The disclosed embodiments of the present invention relate to cloud computing, and more particularly, to a cloud-based system for serving a service request of an embedded device by cloud computing and related cloud-based processing method thereof.

With the development of the semiconductor technology, the computing power of a personal computer is enhanced significantly due to a powerful central processing unit (CPU) with much more transistors included therein. Additionally, as the hard disk drive/solid-state drive and the memory are developed to become cheaper and to have larger storage capacity, the personal computer is allowed to expand its storage space for storing/buffering data and instructions. However, regarding other resource-limited systems such as embedded devices/systems, the computing power is poor and the storage space is limited. Thus, the performance of the embedded device is not as good as that of the personal computer. Due to the limited resource available to the embedded device, the embedded device may have difficulty in performing functions/operations which can be smoothly performed by the personal computer with sufficient system resource.

Therefore, there is a need for an innovative design which can allow the resource-limited system (e.g., an embedded device) to perform those functions/operations which can be smoothly performed by the personal computer.

### SUMMARY

In accordance with exemplary embodiments of the present invention, a cloud-based system for serving a service request of an embedded device by cloud computing and related cloud-based processing method thereof are proposed to solve the above-mentioned problem.

According to a first aspect of the present invention, an exemplary cloud-based system is provided. The exemplary cloud-based system includes a cloud server system with cloud computing capability, and an embedded device coupled to the cloud server system through a network. The embedded device is configured to request the cloud server system for a specific service by generating a service request to the cloud server system.

According to a second aspect of the present invention, an exemplary cloud-based processing method is provided. The exemplary cloud-based processing method includes: utilizing an embedded device to generate a service request for a specific service, and serving the service request by cloud computing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a cloud-based system according to an exemplary embodiment of the present invention.

FIG. 2 is a flowchart illustrating a cloud-based processing method according to an exemplary embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

The cloud computing is location independent computing, whereby shared servers included in a cloud server system at a cloud side provide resources to devices at a client side. More specifically, cloud's network connection speed is extremely fast, cloud's storage is extremely large and cheap, and cloud's computing power is extremely high. The conception of the present invention is to couple a resource-limited system at the client side to the cloud such that functions/operations which require much system resource can be done at the cloud side rather than the client side. In this way, the client device's computing power can be reserved and the hardware requirement can be relaxed. Further details are described as follows.

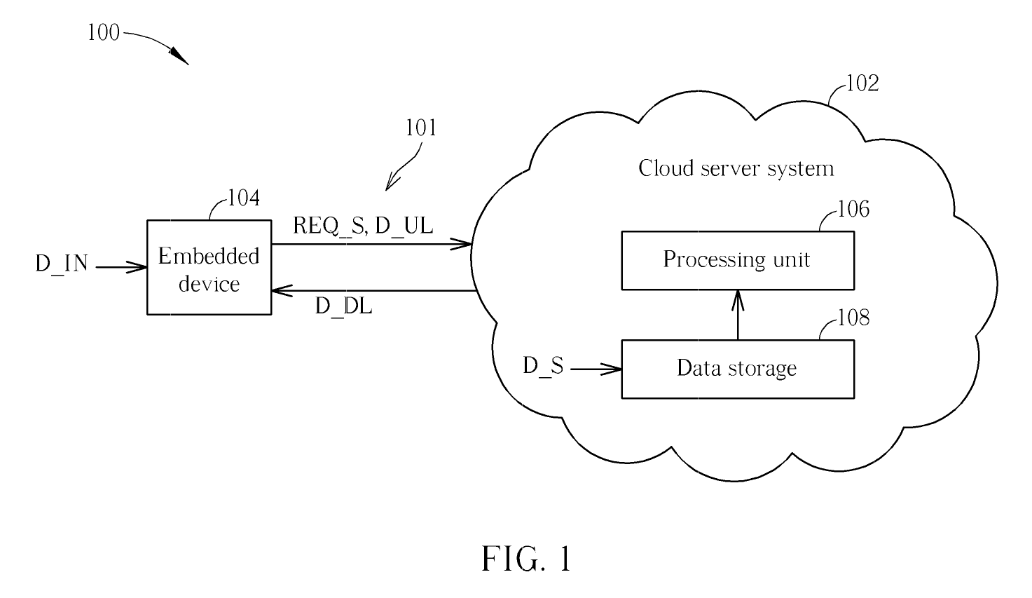

FIG. 1 is a diagram illustrating a cloud-based system according to an exemplary embodiment of the present invention. The exemplary cloud-based system 100 includes, but is not limited to, a cloud server system 102 with cloud computing capability at a cloud side and an embedded device 104 at a client side. The embedded device 104 is coupled to the cloud server system 102 through a network 101. Please note that connection speed of the network 101 is extremely high in accordance to the cloud computing infrastructure. The cloud server system 102 may consist of shared servers and may be conceptually regarded as having a processing unit 106 with extremely high computing power and a data storage 108 with extremely large storage capacity. The embedded device 104 is configured to request the cloud server system 102 for a specific service by generating a service request REQ_S to the cloud server system 104 via the network 101. In other words, due to the limited system resource, the embedded device 104 does not deal with the specific service by itself and asks for assistance of the cloud server system 102 which has sufficient system resource for handling the specific service. In this exemplary embodiment, the embedded device 104 may be a home appliance or a handheld device (e.g., a mobile phone).

By way of example, the embedded device 104 receives an input data DIN and transmits an uploaded data D_UL derived from the input data DIN to the cloud server system 102. Therefore, the cloud server system 102 serves the service request REQ_S by processing a stored data D_S derived from the uploaded data D_UL transmitted via the network 101. In one exemplary implementation, the uploaded data D_UL may be the input data D_IN directly, and the stored data D_S may be the uploaded data D_UL directly. However, to protect the data transmission between the embedded device 104 and the cloud server system 102, further signal processing may be applied to the data to be transmitted. In another exemplary implementation, the embedded device 104 generates the uploaded data D_UL by performing encryption upon the input data DIN, and the cloud server system 102 obtains the stored data D_S by performing decryption upon the uploaded data D_DL. In this way, the data transmission between the embedded device 104 and the cloud server system 102 is secured against malicious interception.

Please note that the aforementioned input data D_IN may be a multimedia content including video information and/or audio information. For example, the input data D_IN includes broadcasting service and live streaming contents. Therefore, the service request REQ_S is particularly associated with data processing of the multimedia content that requires much system resource. By way of example, the specific service requested by the embedded device 104 may be a trick-mode operation selected by the user of the embedded device 104. Therefore, after receiving the service request REQ_S, the processing unit 106 performs the requested trick-mode operation upon the stored data D_S recorded in the data storage 108, and accordingly generates a processed data D_DL to the embedded device 104 in response to the service request REQ_S. As the processing unit 106 is equipped with extremely high computing power and the connection speed of the network 101 is extremely fast, the processed data D_DL required by the trick-mode playback can be supplied to the embedded device 104 smoothly. Upon receiving the processed data D_DL, the embedded device 104 can drive an output apparatus (e.g., a display screen and a speaker system) to present the trick-mode playback requested by the user. To put it simply, the trick-mode playback is realized without consuming much system resource of the embedded device 104. The computing power of the embedded device 104 may be reserved for other local signal processing, leading to optimized performance of the embedded device 104 which has limited system resource.

By way of example, the aforementioned trick-mode operation may be a time-shifting operation. When the user of the embedded device 104 presses a time-shifting button when viewing the multimedia content carried by the input data DIN, the embedded device 104 generates the service request REQ_S to the cloud server system 102, and then the processing unit 106 processes the stored data D_S having the multimedia content interested by the user, and generates the processed data D_DL carrying the time-shifted content to the embedded device 104 for playback. In this way, through the embedded device 104 with limited computing power and storage capacity has difficulty in performing the time-shifting operation by itself, the embedded device 104 is configured to ask the cloud server system 102 for the desired time-shifted content. In other words, the time-shifting operation is started/controlled by the embedded device 104, the time-shifting is done at a cloud side, and the time-shifted content is supplied to the embedded device 104 by the cloud server system 102.

As the data storage 108 has extremely large storage capacity, the embedded device 104 may upload any received input data D_IN to the cloud server system 102 for storage. In other words, the embedded device 104 can store data at the cloud side instead of a local storage. Thus, the data storage requirement of the embedded device 104 can be relaxed, leading to reduction of the production/hardware cost of the embedded device 104. By way of example, the embedded device 104 transmits the uploaded data D_UL to the cloud server system 102 while receiving the input data D_IN. That is, the embedded device 104 starts an upload procedure of the input data D_IN immediately after receiving the input data DIN, thereby significantly reducing the size of the local storage implemented in the embedded device 104. However, this is for illustrative purposes only, and is not meant to be a limitation of the present invention. The spirit of the present invention is obeyed as long as the embedded device 104 transmits the uploaded data D_UL to the cloud server system 102 prior to issuing the service request REQ_S. Therefore, upon receiving the service request REQ_S, the cloud server system 102 can process the stored data D_S derived from the uploaded data D_UL in time for achieving optimum data processing efficiency.

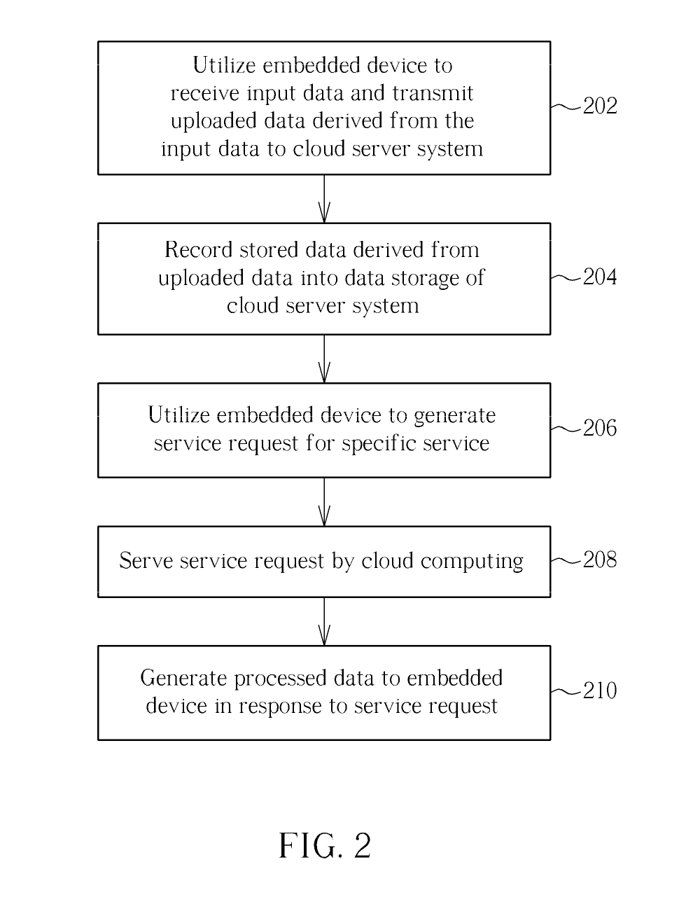

Please refer to FIG. 2, which is a flowchart illustrating a cloud-based processing method according to an exemplary embodiment of the present invention. Provided that the result is substantially the same, the steps are not required to be executed in the exact order shown in FIG. 2. The exemplary cloud-based processing method may be employed by the cloud-based system 100 shown in FIG. 1, and may be briefly summarized by following steps.

Step 202: Utilize an embedded device to receive an input data (e.g., a multimedia content) and transmit an uploaded data derived from the input data to a cloud server system. The embedded device may be a home appliance or a handheld device (e.g., a mobile phone). In one exemplary implementation, the uploaded data may be the input data directly. In another exemplary implementation, the uploaded data may be generated by performing encryption upon the input data.

Step 204: Record a stored data derived from the uploaded data into a data storage of the cloud server system. In one exemplary implementation, the stored data may be the uploaded data directly. In another exemplary implementation, the stored data may be obtained by performing decryption upon the uploaded data.

Step 206: Utilize the embedded device to generate a service request to the cloud server system for a specific service (e.g., a trick-mode operation such as a time-shifting operation).

Step 208: Serve the service request by cloud computing. For example, the requested trick-mode operation (e.g., the time-shifting operation) is done by a processing unit included in the cloud server system.

Step 210: Generate a processed data (e.g., a time-shifted content) to the embedded device in response to the service request.

As a person skilled in the art can readily understand operation of each step shown in FIG. 2 after reading above paragraphs directed to the cloud-based system 100 shown in FIG. 1, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A cloud-based system, comprising:
a cloud server system with cloud computing capability; and
an embedded device, coupled to the cloud server system through a network, the embedded device configured to request the cloud server system for a specific service by generating a service request to the cloud server system.

2. The cloud-based system of claim 1, wherein the embedded device receives an input data and transmits an uploaded data derived from the input data to the cloud server system; and the cloud server system serves the service request by processing a stored data derived from the uploaded data.

3. The cloud-based system of claim 2, wherein the embedded device generates the uploaded data by performing encryption upon the input data, and the cloud server system obtains the stored data by performing decryption upon the uploaded data.

4. The cloud-based system of claim 2, wherein the input data is a multimedia content.

5. The cloud-based system of claim 4, wherein the specific service is a trick-mode operation, and the cloud server system performs the trick-mode operation upon the stored data and accordingly generates a processed data to the embedded device in response to the service request.

6. The cloud-based system of claim 5, wherein the trick-mode operation is a time-shifting operation.

7. The cloud-based system of claim 2, wherein the embedded device transmits the uploaded data to the cloud server system while receiving the input data.

8. The cloud-based system of claim 1, wherein the embedded device is a home appliance.

9. The cloud-based system of claim 1, wherein the embedded device is a handheld device.

10. The cloud-based system of claim 7, wherein the handheld device is a mobile phone.

11. A cloud-based processing method, comprising:
utilizing an embedded device to generate a service request for a specific service; and
serving the service request by cloud computing.

12. The cloud-based processing method of claim 11, further comprising:
utilizing the embedded device to receive an input data and transmit an uploaded data derived from the input data;
wherein the cloud computing serves the service request by processing a stored data derived from the uploaded data.

13. The cloud-based processing method of claim 12, further comprising:
generating the uploaded data by performing encryption upon the input data; and
obtaining the stored data by performing decryption upon the uploaded data.

14. The cloud-based processing method of claim 12, wherein the input data is a multimedia content.

15. The cloud-based processing method of claim 14, wherein the specific service is a trick-mode operation, and the step of serving the service request by cloud computing comprises:
performing the trick-mode operation upon the stored data and accordingly generating a processed data to the embedded device in response to the service request.

16. The cloud-based processing method of claim 15, wherein the trick-mode operation is a time-shifting operation.

17. The cloud-based processing method of claim 12, wherein the embedded device transmits the uploaded data while receiving the input data.

18. The cloud-based processing method of claim 11, wherein the embedded device is a home appliance.

19. The cloud-based processing method of claim 11, wherein the embedded device is a handheld device.

20. The cloud-based processing method of claim 17, wherein the handheld device is a mobile phone.
